(19) United States
(12) Patent Application Publication
(10) Pub. No.: US 2006/0034747 A1
(43) Pub. Date: Feb. 16, 2006

(54) Furnace for the manufacture of carbon fibers, and a procedure for obtaining fibers using the furnace

(75) Inventors: Cesar Merino Sanchez, Burgos (ES); Pablo Soto Losada, Burgos (ES)

Correspondence Address: WILLIAM COLLARD;COLLARD & ROE, P.C., 1077 NORTHERN BOULEVARD, ROSLYN, NY, 11576, US

(73) Assignee: GRUPO ANTOLIN-INGENIERIA, S.A.

(21) Appl. No.: 11/134,238

(22) Filed: May 20, 2005

(30) Foreign Application Priority Data
May 20, 2004 (EP) EP04381014.2

(51) Int. Cl. D01F 9/12; B32B 27/04

(52) U.S. Cl. 423/447.3; 422/150; 422/152

(57) ABSTRACT

A furnace for the manufacture of carbon fibers comprising a set of reaction tubes and an auxiliary installation required for its operation. There is also disclosed a procedure for manufacture of these fibers and the fibers obtained. The furnace has a set of reaction tubes vertically arranged and forming a single block with common heating that reduces the heat losses maintaining the modularity and scalability of the furnace. Each of these reactor tubes has an individual feed with the possibility of carrying out a cleaning of each of the tubes without the production being interrupted in the tubes.

### CROSS REFERENCE TO RELATED APPLICATIONS

Applicants claim priority under 35 U.S.C. §119 of EP 04381014.2 filed on May 20, 2004 the disclosure of which is hereby incorporated herein by reference.

### BACKGROUND OF THE INVENTION

There can be known carbon nanofibers which are carbon filaments of submicrometric size with a highly graphic structure, wherein these nanofibers are grown in the vapor phase called s-VGCF that are located between carbon nanotubes and commercial carbon fibers. This can occur even though the limit between the carbon nanofibers and multilayer nanotubes is not clearly defined.

These carbon nanofibers can have a diameter which is generally between 30 nm and 500 nm and a length greater than 1 μm.

There is scientific literature in which the physical-chemical characteristics of the nanofiber and the process for the creation of this nanofiber are described.

These models have been created based upon laboratory experiments using controlled atmospheres combined with observations with electronic sweeping or transmission microscopes.

In this case, carbon nanofibers are produced by catalysis from the decomposition of hydrocarbons on the metallic catalytic particles originating from compounds with metal atoms, thereby forming nanometric fibrilar structures with highly graphitic structures.

Studies exist such as those in the Oberlin Journal of Crystal Growth 32, 335 (1976) wherein the growth of carbon filaments on metallic catalytic particles is analyzed by transmission electronic microscopy.

Based upon these studies, Oberlin proposed a growth model based upon the diffusion of carbon around the surface of the catalytic particles until the surface of the particles is contaminated by an excess of carbon.

This article explained that deposition due to thermal decomposition of carbon is responsible for the thickening of the filaments, and wherein this process occurs along with the growth process and is thus very difficult to avoid.

Thus, once the growth process has ended, by for example, contamination of the catalytic particle, the thickening of the filament continues if the conditions of pyrolisis continue to exist.

In addition, other growth models have been proposed that have also been examined that have resulted in similar results to those found in the laboratory experiments.

The metallic catalytic particles are formed by transition metals with the atomic number being between:
21 and 30 (Sc, Ti, V, Cr, Mn, Fe, Co, Ni, Cu, Zn) between
39 and 48 (Y, Zr, Nb, Mo, Tc, Ru, Rh, Pd, Ag, Cd) or between
73 and 78 (Ta, W, Re, Os, Ir, Pt). It is also possible to use Sn, Ce, and Sb wherein those of Fe, Co, and Ni are also used or being especially indicated.

Different chemical compounds can be in use as a source of metallic catalytic particles for the continuous production of carbon nanofibers, such as inorganic and organic metallic compounds.

There is a huge jump between the means and methods of production from laboratory results to obtaining industrial quantities of nanofibers in acceptable conditions from both the engineering and economic cost point of view.

At an industrial level, the catalytic metallic particles can be classified into two groups, with a substrate, and without a substrate.

In the first case, when the metallic particles are provided with a substrate, fibers are obtained for applications wherein they are aligned with their electron emission sources for microelectronic applications.

In the second case, also called floating catalyst, the reaction occurs in a given volume without the metallic particle being in contact with any surface. Thus, it is not required to separate the nanofibres produced from the substrate.

It is improbable that the carbon nanofibres grow directly from the initial carbon source. It is believed that the filaments appear from secondary products created from the thermal decomposition of the initial carbon source.

Some authors mention that for light hydrocarbons, lower than C16 any of them can be used, without the quality of the nanofiber obtained depending on the hydrocarbon chosen.

Carbon nanofibers are used to make charged polymers giving rise to materials with improved properties, such as resistance to stress, elasticity modules, electrical conductivity and thermal conductivity. Others applications are, for example, their use in tires partially replacing carbon black, or in lithium-ion batteries since the carbon nanofibres are easily interspersed with lithium ions.

After examining the nanofiber growth models the deposition due to thermal decomposition of carbon is responsible for the thickening of the filaments produced along with the growth process. This thickening continues if the conditions of pyrolisis continue to exist. As a consequence, in an industrial furnace the thickening continues if the nanofiber is kept in the reactor.

The residence time of the fibers in the reactor is very important since the greater the residence time, the greater the diameter of the fibers produced.

The manufacture of this type of nanofiber in industrial processes has been considered by means of techniques such as that described in the Japanese patent JP60027696, where use is made of a number of reaction tubes placed horizontally and in parallel to work in the vapor phase and with the catalyst fixed on a substrate.

In these type of reaction tubes, the compilation of the fiber is discontinuous since it grows on the substrate where the substrate is covered with catalytic particles.

As the patent describes, also in this device resistances or insulators are used in a block with thermal insulation.

In general, when the floating catalyst technique is used with horizontal furnaces, there is a disadvantage wherein either one works with very high gas flows that are capable of drawing the fiber produced to the outside of the furnace, or wherein the fibers, once created, can remain inside the furnace a fairly long time, with the consequent loss of properties due to the thickening of the fiber as a consequence of the deposition of pyrolitic carbon on the surface of the fibre.

In the vertical furnace, in contrast, it is possible to have greater control of the residence time of the fibers produced inside the furnace, and thus to avoid the unwanted thickening of the fibers due to pyrolitic deposition of carbon.

The present invention comprises a new design for the furnace that allows continuous production of high quality fiber and with reduced costs, along with the auxiliary installation that supplies it, to be obtained.

### SUMMARY

There is a furnace for the manufacture of carbon fibers comprising a set of reaction tubes and the auxiliary installation required for its operation. There is also a procedure for obtaining and using this furnace and the fiber obtained from using this furnace.

The furnace can include a set of reaction tubes vertically placed forming a single block with a common heating element.

This layout with the common heating element reduces the heat losses while increasing the energy efficiency of the reaction without affecting the modularity and scalability of the furnace.

The independence of each of these tubes reactors allows for the adjustment of each individual control and feed to the actual conditions. This design allows for the possibility of carrying out the cleaning of each of the tubes without production being interrupted in the remaining tubes.

In addition, the use of a common collector for the fiber collection and its configuration allow greater simplicity and for greater simplification in installation.

In addition, the installation is configured as a closed and sealed circuit avoiding the escape of gasses and thus allowing the reuse of the residual process gas. This results in a process wherein there is a notable saving in energy by having avoided part of the supply of the reagent gasses. Therefore, this result is because it can be verified in practice wherein the residual gas is part of a quality that is equivalent to that of gasses used in a raw material.

The end result is a new or novel fiber or nanofiber which can be obtained from this procedure or process.

There is a furnace for the manufacture of carbon fibers that has a set of auxiliary elements for its correct supply and evacuation of both the combustion gases and the fiber obtained, as well as allowing the periodic and independent cleaning of each of the tubes that make up the furnaces.

This furnace comprises a set or grouping of tubes, preferably ceramic to avoid problems of corrosion due to the reagent gases, placed in a vertical position.

The heating of the tubes to reach the pyrolisis temperature of the hydrocarbon occurs by means of a block of insulators covered with thermal insulation, that prevents escape of heat to the outside. By being a common block, the construction is simple and the insulation more effective, avoiding to the maximum temperature loss, optimizing the use of electric power necessary for heating. This common block of resistances or insulators can however be formed as a grouping of the individual resistances or insulators of each reactor tube forming a single set, for example because the reactor tubes are fabricated with the resistance or insulation incorporated.

The ceramic tubes are completely within the block of insulation. The union of the ceramic tubes to the rest of metallic parts of the installation occurs using metallic tubes, both in the upper and in the lower part of each ceramic tube. A number of jackets, through which a cooling liquid circulates, surround the metallic tubes. These jackets create a low temperature at the points of contact of the ceramic and metallic material, and prevent a rupture of the ceramic material being produced, which is caused by the different dilation of the materials, as well as the possible burning of the closing and sealing joints between both tubes.

Each of the tubes is supplied, independently from the others, with a catalyst, hydrocarbon and a diluting gas such as, for example, hydrogen.

Feed occurs at a pressure greater than atmospheric before entering the tube, whereas the lower collector forms part of a recirculation circuit situated at a pressure lower than atmospheric pressure.

With each furnace being independently supplied, it also has independent outlet valves, so that any of the furnaces can remain out of service without affecting the rest of the installation.

This furnace is designed so that portions of it can be isolated and then cleaned.

Although most of the production of fiber occurs in the core of the descending gas flow (without substrate), it is possible that some particle of catalyst may enter in contact with the wall of the furnace tube.

The growth of fiber from these particles that is deposited on the wall gives rise to the existence of an accumulation of fiber on the walls, dirtying and gradually obstructing the tube.

The procedure of cleaning the tube occurs without stopping the productive process in the furnace, instead, the tube that must be cleaned is isolated by closing the lower valves and the hydrocarbon and catalyst feed valves.

Once the inert gas has swept any remains of hydrocarbon, the feed is replaced with air and therefore with a supply of oxygen.

The presence of oxygen produces the combustion of the carbon that is swept away and eliminated. Once the combustion has been completed, the furnace is again fed with the inert gas, until it eliminates the oxygen.

Nitrogen is a gas which is possible to consider inert at the working temperatures of the furnaces and it is of low cost, although it is possible also to use noble gases in the case of it being necessary.

After this operation, the furnace is ready to continue in production, so that the catalyst, hydrocarbon and diluting gas feed valves are again opened.

The fiber obtained in each of the furnaces comes to a single sloping collector that facilitates drawing, both by gravity and by the flow forced by means of a residual gas impeller, to a pressurized collection tank. This single collector results in a simplified installation that avoids a large number of bends and valves that create stagnation and discontinuous flow in the collection of the nanofiber.

Both the valves placed to the outlet of each of the tubes, and the oblique collector are elements that form part of this invention.

The residual gas re-circulates in a circuit part of which is formed by the collector. The residual gas impeller mentioned previously creates this recirculation.

The residual gas, adequately treated and pressurized until reaching the feed pressure, is partially re-used, drastically reducing the cost requirements for raw material.

The mass control of each of the reagents, of the dilutent and of the residual gas used in the back-feed occurs via a control system that adjusts the appropriate values for each of the furnaces. Every furnace has its independent apportioning and the valves necessary for isolating it or for connecting it with the rest of the installation.

The fiber obtained by this procedure has a very high degree of homogeneity with regard to the dimensional parameters (diameter and length), as well as mechanical characteristics (modulus of elasticity and tensile resistance), and physical (thermal and electrical conductivity) which is very interesting for its industrial use.

This process is also very economical because it allows for the individualized cleaning stages of each of the tubes, by using commercial sizes of ceramic tubes. The manufacture of tubes with other special sizes implies amortization in the long term and an increase in price of the carbon nanofiber produced.

The use of a furnace that consists of independent reaction tubes facilitates the scaling of a plant in accordance with the production required. To scale the production up or down one need only incorporate more or less tubes. Because of the setup and advantages stated previously, any size of installation can be made, from one furnace up to any number, depending on the need for production required.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a schematic diagram of an embodiment of the invention consisting of a set of reaction tubes an auxiliary parts that complete the installation to carry out the creation of fiber; and

FIG. 2 shows a histogram obtained from statistical reading of the average diameter with a high sampling size for the fiber manufactured via the design shown in FIG. 1, wherein on this histogram, the corresponding fit normal or gauss probability density function is shown.

### DETAILED DESCRIPTION OF PREFERRED EMBODIMENTS

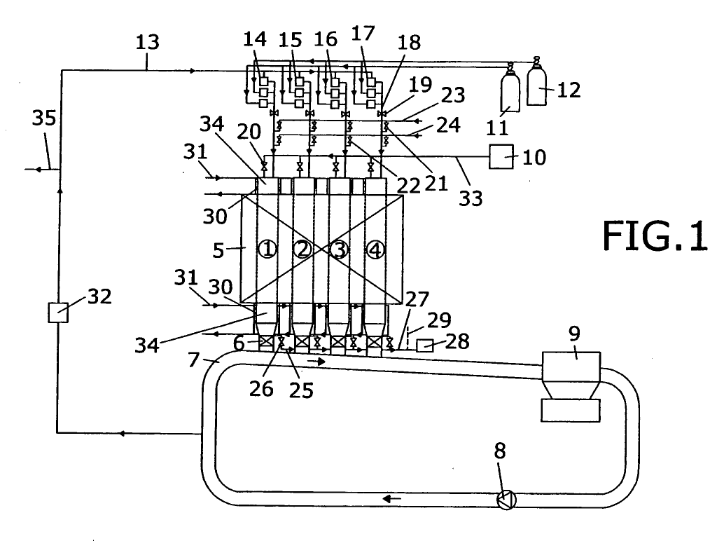

Turning now in detail to the drawings, FIG. 1 shows a schematic diagram of an embodiment that uses a furnace formed by four vertical tubes 1, 2, 3, 4 respectively, wherein these tubes are of the same diameter and length, forming a single block 5 lined with resistances and insulation.

There can be a reaction inside of these tubes wherein the temperature of the reaction is between 800 and 1500° C. wherein this temperature can be reached by heating of these insulators or resistances.

The input of these components to the reaction tubes 1, 2, 3, 4 can occur via their top part and the output of the nanofibers and the residual gas of the reaction via its lower part.

Both zones, including the input and output zones of the reaction tubes 1, 2, 3, 4, must be at temperatures lower than those of the reaction, this occurs with the input of components to protect the devices and with the output of the products so that these may be collected wherein these gases lose part of their chemical activity so that these gasses can then be handled.

The upper and lower ends of each of these tubes 1, 2, 3, 4, that make up the furnace have a metallic tube with a refrigerating jacket 30 through which there is a refrigerated liquid, which circulates there-through, and which can be supplied by means of a hydraulic pipe 31. At the points of contact of the ceramic and metallic material, there must be a low temperature, to prevent the rupture of the ceramic material which can be produced and caused by a different dilation of the materials wherein there can also be a possible burning of the closing and sealing joints between the two tubes.

In the lower part of these tubes, and in each of these tubes, 1, 2, 3, and 4, there is a valve 6 that leads to a collector 7 that collects the product of the reaction including carbon nanofibers and the residual gas.

The collector 7 can be a collection pipe with an essentially closed ring configuration. In this ring, there are two more important parts: there is an impeller 8 of the gasses that provides the thrust necessary for the circulation of the gasses and the nanofiber in the same direction, and a system of nanofiber collection without detaining the gas flow.

This collector part can be placed under tubes 1, 2, 3, 4 and has a slope that facilitates the conduction of carbon nanofibers up to a nanofiber collection device 9. In this device, the separation of nanofibers and gasses occurs, wherein the nanofibers remain stored without blocking the way of the residual reaction gas which continues its way inside of a collector ring 7.

From the system of collection 9, only gasses circulate until they again encounter the nanofibers and the output gasses of the reaction tubes.

Within this type of a closed ring, and in the reaction tubes, there is a pressure constant that is less than atmospheric between −1 and −200 mbar. In the rest of the installation, there is a constant overpressure of between 100 mbar and 1 bar.

The differences in pressure between the supply zone and that of the output in the installation is obtained principally using a means of pressure control 32 which is set within a range.

The components that form part of the chemical reaction are introduced throughout the upper part of the tubes 1, 2, 3, 4. These components are in the form of:
a compound with a catalytic metallic particle, in a vapor phase 10, with preferably all of them with a transition metal and, especially iron cobalt or nickel. These elements can include ferrocene, iron or pentacarbonite;
a hydrocarbon such as natural gas or other industrial gases;
a gas diluting gas for example, hydrogen;
a re-circulation gas, introduced through the recirculation pipe.

In this case, the use of natural gas as a source of carbon therefore requires the use of ceramic reaction tubes. In this case, natural gas is composed of methane, and in small quantities other components such as sulphur compounds. These sulphur compounds and the temperature at which this reaction occurs corrode iron and any metallic alloy. Ceramic materials can be inert for any type of reaction, both through reduction and oxidation and therefore are an ideal material for using in reaction tubes.

All of the components, except the compound with metallic catalytic particles, which are used to feed the furnaces, are apportioned in their appropriate quantities via mass controllers 14, 15, 16, 17, one for each gas and reaction tube. Thus, with these four reaction tubes, and the three process gasses, there are 12 mass or ground controllers.

In each reaction tube, 1, 2, 3, 4, these components are introduced via the high part of the tubes 1, 2, 3, 4, through pipes 18 and 33 wherein there are valves 19 and 20 which function as described below:

During the chemical reaction, the nanofibers are formed within the reaction tubes, some metallic catalytic particles are also deposited on the internal walls. These internal walls also support the growth of carbon fiber.

The fiber maintains its bond with the internal walls of the reaction tubes 1, 2, 3, 4 and therefore attracts other metallic catalytic particles. In this way, carbon nanofibers grow continuously from the internal walls of the tubes that could manage to decrease the production in these tubes.

Thus, it is necessary for there to be a consistent cleaning of the carbon nanofibers, by burning the carbon nanofibers and by achieving their detachment and drawing away for their evacuation.

For the cleaning of the reaction tube, the production of carbon nanofibers is stopped wherein the supply valves of the reagent components and the reaction product collection valve in the lower part of the tubes are closed.

In this case there is a valve 21 which allows for the introduction of an inert gas to stop the chemical reaction and wherein there is also a valve 26 for the evacuation of gasses that are simultaneously opened. Once this process occurs, nitrogen can be introduced as an inert gas.

This inert gas can be introduced through a pipe 23 that has branchings to each tube, wherein this inert gas can be controlled via valves 21.

In this case, this gas draws away gasses and nanofibers of the reaction to the part of reaction tubes 1, 2, 3, 4 that pass out through a pipe 25 of each reaction tube and pass through a valve 26 to reach a common collection pipe 27 which in turn discharges into a means for collecting 28 of nanofibers and gasses which can be in the form of a container.

Associated with this common pipe 27, is a control system 29 that detects when the reagent gasses have been expelled, so as to keep a sufficient amount of hydrocarbons below a minimum level.

At this point or moment, an inert gas pass valve 21 is closed and then the input valve 22 for the air that circulates through pipe 24 is opened. In this case, the carbon reacts with the oxygen of the air producing a combustion and release of nanofibers from an internal wall of tubes 1, 2, 3, 4 wherein these nanofibers are drawn away to the container or means for collection 28 of ashes and gases.

Air is introduced into the system until analyzer 29 stops detecting a particular level of carbon monoxide and carbon dioxide that are the principal compounds formed by burning the nanofibers.

Thus, when the analyzer detects this level, the air introduction valve 22 is closed, and the inert gas introduction valve 21 is opened. This is done to clean the tubes 1, 2, 3, 4 of oxygen wherein this inert gas introduction valve is kept open until analyzer 29 does not detect any oxygen in the tubes.

To resume production, the air introduction valves and the evacuation valves 26 are closed. In addition, the following valves are opened: the fiber production and residual gas output valves 6, hydrocarbon and diluting gas supply valve 19, and the catalyst supply valve 20.

In this case, the production of fiber may require one or more of the tubes 1, 2, 3, 4 to accommodate the scale of production.

Tubes 1, 2, 3, 4 can be laid out forming a grouping that allows the production of a nanofiber and their cleaning that can be performed independently thus using any combination of the tubes with each other. Thus, it is possible to have tubes that are being cleaned and tubes that produce carbon nanofibers at the same time.

In addition, it is also possible to adjust the production levels using only some of these tubes and keeping the rest of the tubes with their valves closed and out of service, with neither the efficiency or the quality of the fiber being reduced.

With this design, the cleaning procedure of a reaction tube can be considered to be a sub-stage of the production procedure for the use of the furnace as well as the rest of the auxiliary elements.

From this production condition, these carbon nanofibers that have been manufactured are then analyzed to determine their quality and structural characteristics.

These fibers are observed with a microscope at different scales, such that there is shown a very high degree of homogeneity and absence of impurities.

Therefore, from this statistical point of view, there have been various dimensional readings to determine the diameter and length of the fiber obtained.

These parameters depend principally on the quality of the reaction conditions, the activity of the metallic catalytic particle and on the permanence time of the catalytic particle in the reaction conditions without it being contaminated.

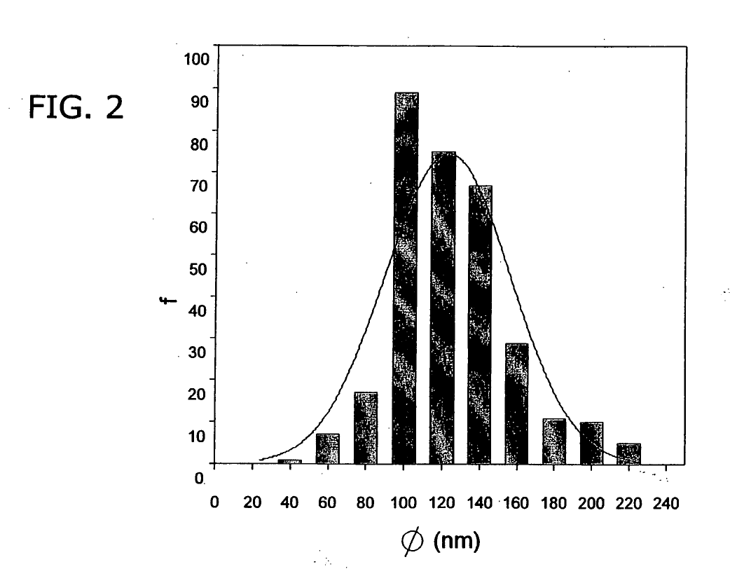

FIG. 2 shows a histogram corresponding to a sampling size of a diameter of 311 readings sufficient enough to establish an approximation of the probability density function.

This function has been fitted using a normal, average or Gauss function that is shown superimposed on the histogram.

To estimate the average, a value of 122.96 nm has been obtained and is used for the standard deviation of 33.16 of all of the samples being within the range of 32.25 to 228.09. In this case, standard deviations less than 40 nm are appropriate for dispersion values in most of these applications.

Fiber diameters that are between 30 and 500 nm are accepted as valid wherein these fibers are not rejected because samples outside of these values are accepted when the values of the average and the standard deviation indicate a large percentage of the fibers that are fabricated are inside of this interval.

In addition, an acceptable production batch would be that 80% of the area corresponding to the normal or gauss probability density function used in the samples measured are within the interval between 30 and 500 nm for a sufficiently representative sample.

In addition, for a production wherein the average diameter variable obtained on the Gauss or normal probability density function used within this fit is within a range of 80 nm, and 180 nm, in this case this measured sample is much better with the lesser the degree of dispersion.

With this same example, the fibers that have been obtained have a length between 20 and 200 micrometers. In this case, the length has a very high variance wherein its validity depends highly on the later application of the fiber.

These variations in materials shapes, sizes and layout in the component parts can be described in a non-limiting way and do not alter the essential nature of the invention, wherein this design is sufficient for its reproduction to be undertaken by an expert.

Accordingly, while a few embodiments of the present invention have been shown and described, it is to be understood that many changes and modifications may be made thereunto without departing from the spirit and scope of the invention as defined in the appended claims.

What is claimed is:

1. A furnace for the manufacture of carbon fibers comprising:
an insulating block;
a plurality of reaction tubes coupled to said insulating block;
a plurality of pipes coupled to said plurality of reaction tubes;
a plurality of valves with at least one valve coupled to at least one of said plurality of pipes;
a plurality of pass valves wherein for each of said reaction tubes, there is at least one pass valve coupled to an output end of said reaction tubes at a first end; and
at least one collector coupled to said plurality of pass valves opposite an end being coupled to said output end of said reaction tubes.

2. The furnace for the manufacture of carbon fibers as in claim 1, wherein said insulating block is formed as a plurality of insulating elements each surrounding at least one reaction tube.

3. The furnace for the manufacture of carbon fibers as in claim 1 further comprising a plurality of jackets that surround said upper and lower ends of said plurality of reaction tubes, wherein said jackets allow for the circulation of cooling liquid for the reduction in temperature to a point below pyrolisis.

4. The furnace for the manufacture of carbon fibers as in claim 1, further comprising mass or material controllers which can be used to apportion quantities and supply hydrocarbon, dilutent, and recycled gasses.

5. The furnace for the manufacture of carbon fibers as in claim 1, wherein said at least one collector is used to evacuate fiber and residual gasses.

6. The furnace for the manufacture of carbon fibers as in claim 1, wherein said collector is shaped as a closed ring with a gas impeller which has the capacity to generate gas velocities sufficient to achieve a drawing away of the fiber.

7. The furnace for the manufacture of carbon fibers as in claim 6, further comprising a fiber collection device, wherein said ring collector is interrupted by said fiber collection device that does not block the passing of the recirculating gas.

8. The furnace for the manufacture of carbon fibers as in claim 6, wherein the entire installation is sealed.

9. The furnace for the manufacture of carbon fibers as in claim 1, further comprising a back feed pipe that leads the gas from said residual gas recirculation collector to a feed.

10. The furnace for the manufacture of carbon fibers as in claim 9, wherein said back feed pipe further comprises a control element for controlling the pressure of the recirculating gas wherein said pressure of the recirculating gas can be readjusted within a range to a feed pressure.

11. The furnace for the manufacture of carbon fibers as in claim 1, further comprising an ash collection system and a set of alternative feed and evacuation pipes coupled to at least one of said plurality of reaction tubes wherein said feed and evacuation pipes lead to said ash collection system which can be used for individualized cleaning of each reaction tube.

12. The furnace for the manufacture of carbon fibers as in claim 11, wherein said feed pipes comprise at least two pipes, including at least one air pipe and at least one inert gas pipe and wherein the furnace further comprises valves wherein at least one valve is coupled to at least one feed pipe before said feed pipe enters said at least one reactor tube.

13. The furnace for the manufacture of carbon fibers as in claim 12, wherein said inert gas is nitrogen.

14. The furnace for the manufacture of carbon fibers as in claim 12, wherein said inert gas is a noble gas.

15. The furnace for the manufacture of carbon fibers as in claim 12, further comprising a means for evacuation in cleaning operations, wherein said means comprises a plurality of pipes that converge into a single pipe wherein each pipe of said plurality of pipes has a valve placed adjacent to an output of each reactor tube.

16. The furnace for the manufacture of carbon fibers as in claim 11, further comprising a cleaning output that has a control system for determining the moment in which the cleaning operation has ended.

17. A procedure for obtaining carbon fiber comprising the following steps:
growing fiber in a vapor phase from metallic catalytic particles in a reaction tube;
using a hydrocarbon feed of a catalyst and a dilutent plus recycled gasses in proportions determined by a control system;
applying a cleaning stage on any of said reaction tubes based upon a degree of accumulation of fiber in the interior;
returning the tube back to production after said step of applying a cleaning stage; and
collecting said fiber in a collection and storage means.

18. The procedure for obtaining carbon fiber using a furnace as in claim 17, wherein said step of applying a cleaning stage includes applying said cleaning stage to at least one reaction tube without stopping production in at least one remaining reaction tube.

19. The procedure for obtaining carbon fiber wherein said step of applying a cleaning stage comprises the following steps:
closing at least one feed valve and at least one evacuation valve to isolate at least one reaction tube from a remaining portion of an installation;
opening an inert gas feed valve to detain a reaction of carbon fiber formation, and opening said valve of access to a gas feed pipe and reaction pipe;
maintaining an inert gas feed until a control system detects an absence of hydrocarbonated compounds;
closing an inert gas feed valve;
opening an air feed valve for combustion of the carbon fiber with oxygen in high temperature conditions;
continuing a feed of air until a control system confirms an extinction of a combustion reaction, by detecting a presence of carbon and oxygen compounds;
closing said air input valve and opening said inert gas input valve until oxygen has been completely eliminated as detected by said control system due to an absence of carbon and oxygen compounds;
closing inert gas feed valves and a gas and ash evacuation pipe valve; and
opening feed valves and gas and fiber output valves to establish production again.

20. The process as in claim 17, wherein said process produces a set of fibers that satisfies the statistical criteria in that 80% of an area of a Gauss or normal probability density function used in a statistical fit of a diameter measured is within an interval of between 30 nm and 500 nm.

21. The process as in claim 17, wherein the statistical average obtained for a diameter variable is within the range of 80 nm and 180 nm.

22. The process as in claim 17, wherein the standard deviation of a gauss or normal probability density function used in a statistical variable of a measured diameter is less than or equal to 40 nm.
